(19) United States
(12) Patent Application Publication
(10) Pub. No.: US 2026/0138471 A1
(43) Pub. Date: May 21, 2026

(54) LOCK MECHANISM

(71) Applicant: TOYOTA JIDOSHA KABUSHIKI KAISHA, Toyota-shi, (JP)

(72) Inventors: Makoto KUZE, Chiryu-shi (JP); Takanori SATAKE, Toyokawa-shi (JP); Hao SHINDO, Nagoya-shi (JP)

(73) Assignee: TOYOTA JIDOSHA KABUSHIKI KAISHA, Toyota-shi (JP)

(21) Appl. No.: 19/262,582

(22) Filed: Jul. 8, 2025

(30) Foreign Application Priority Data
Nov. 18, 2024 (JP) 2024-200528

(51) Int. Cl. B60L 53/16; H01R 13/639

(52) U.S. Cl. CPC B60L 53/16; H01R 13/639

(57) ABSTRACT

When the first switch and the second switch are turned on (connection state) and the actuator is energized, the lock mechanism of the charging connector is brought into the locked state. The first switch is provided on a power line that connects the power supply and the actuator. The second switch is provided in a power line that connects the actuator and the ground. When at least one of the first switch and the second switch is turned off (cutoff state), the actuator is de-energized and the lock mechanism of the charging connector is brought into the unlocked state. Even when a short-to-power occurs on the power line connecting the power supply and the actuator, or a short-to-ground occurs on the power line connecting the actuator and ground, the actuator can be de-energized and the locked state can be released.

### CROSS-REFERENCE TO RELATED APPLICATION

This application claims priority to Japanese Patent Application No. 2024-200528 filed on Nov. 18, 2024. The disclosure of the above-identified application, including the specification, drawings, and claims, is incorporated by reference herein in its entirety.

### BACKGROUND

### 1. Technical Field

The present disclosure relates to a lock mechanism, particularly, a lock mechanism that locks a charging connector connected to an inlet.

### 2. Description of Related Art

Japanese Unexamined Patent Application Publication No. 2014-87198 (JP 2014-87198 A) discloses a plug lock mechanism that fixes (locks) a plug (connector) of a charging cable in a state where the plug is not removable from a charging port (inlet). The plug lock mechanism of the JP 2014-87198 A determines the presence or absence of an abnormality based on a monitor signal indicating a state of the plug lock mechanism and an unlock request signal, and includes a forced unlocking control drive unit configured to release a locked state and brings the plug lock mechanism into an unlocked state when the abnormality occurs.

### SUMMARY

The lock mechanism of JP 2014-87198 A includes a motor or an actuator that operates a mechanical mechanism for locking. In a case where the motor or the actuator is operated by being energized, when the power supply line to the actuator or the like is short-to-power or short-to-ground, the locked state may not be released and the locked state may not be transitioned to the unlocked state.

An object of the present disclosure is to enable the locked state to be released even when short-to-power or short-to-ground occurs in a power supply line to an actuator that operates a lock mechanism.

The lock mechanism of the present disclosure is a lock mechanism that locks a charging connector connected to an inlet. The lock mechanism includes an actuator that brings the charging connector into a locked state when energized and brings the charging connector into an unlocked state when de-energized, a first switch provided on a power supply side of the actuator, a second switch provided on a ground side of the actuator, and a control device. The control device includes a first controller that brings the charging connector into the locked state by bringing the first switch into a connection state and the second switch into a connection state.

With this configuration, the lock mechanism switches the locked state and the unlocked state by the actuator that brings the charging connector into the locked state when energized and brings the charging connector into the unlocked state when de-energized. The first controller of the control device brings the charging connector into the locked state by bringing the first switch into the connection state and the second switch into the connection state. The first switch is provided on a power supply side of the actuator, and the second switch is provided on a ground side of the actuator. When the power supply side of the actuator is shorted to the power, the second switch is brought into a cutoff state, the actuator is de-energized, and the charging connector is brought into the unlocked state. When the ground side of the actuator is shorted to the ground, the first switch is brought into a cutoff state, the actuator is de-energized, and the charging connector is brought into the unlocked state. Therefore, even when a short-to-power or a short-to-ground occurs on the power supply line to the actuator, the locked state can be released.

The control device may include a second controller that, when an abnormality occurs in the first controller, brings at least one of the first switch and the second switch into a cutoff state and brings the charging connector into the unlocked state.

With this configuration, even when the abnormality occurs in the first controller, the second controller can bring the charging connector into the unlocked state by bringing the first switch or the second switch into the cutoff state.

The lock mechanism may further include a first signal line connected to the first controller, a second signal line connected to the first controller, and a third switch controlled by the second controller. The first switch is brought into the connection state when a connection command is output from the first controller to the first signal line. The second switch is brought into the connection state when a connection command is output from the first controller to the second signal line. A command of at least one of the first signal line and the second signal line is a cutoff command when the third switch is connected by the second controller.

With this configuration, the third switch is connected by the second controller, so that the command of the first signal line and the second signal line can be the cutoff command. Therefore, even when the abnormality occurs in the first controller, the second controller can bring the charging connector into the unlocked state by bringing the first switch or the second switch into the cutoff state.

The lock mechanism may further include a first signal line that is connected to the first controller, a second signal line that is connected to the first controller, and a circuit that, when the first controller is activated, generates connection commands to the first signal line and the second signal line to bring the first switch into the connection state and the second switch into the connection state, and to bring the charging connector into the locked state. The first controller outputs commands to the first signal line and the second signal line after being activated.

With this configuration, when the first controller is activated, such as when the first controller is reset by the watchdog timer or when the first controller returns from the sleep state, the connection command is generated on the first signal line and the second signal line, and the locked state of the charging connector is maintained. As a result, the charging connector can be suppressed from being unintentionally brought into the unlocked state. In addition, after the first controller is activated, the first controller or the second controller can switch the locked state to the unlocked state.

According to the present disclosure, even when the short-to-power or short-to-ground occurs in the power supply line to the actuator that operates the lock mechanism, the locked state can be released.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle and charging equipment according to the present embodiment;

FIG. 2 is a diagram illustrating a schematic configuration of a lock mechanism;

FIG. 3 is a diagram illustrating the short-to-power or short-to-ground in the lock mechanism; and

FIG. 4 is a diagram illustrating a schematic configuration of a lock mechanism in a modification.

### DETAILED DESCRIPTION OF EMBODIMENTS

An embodiment of the present disclosure will be described in detail with reference to the drawings. In the drawings, the same or similar portions are represented by the same reference numerals, and description thereof will not be repeated.

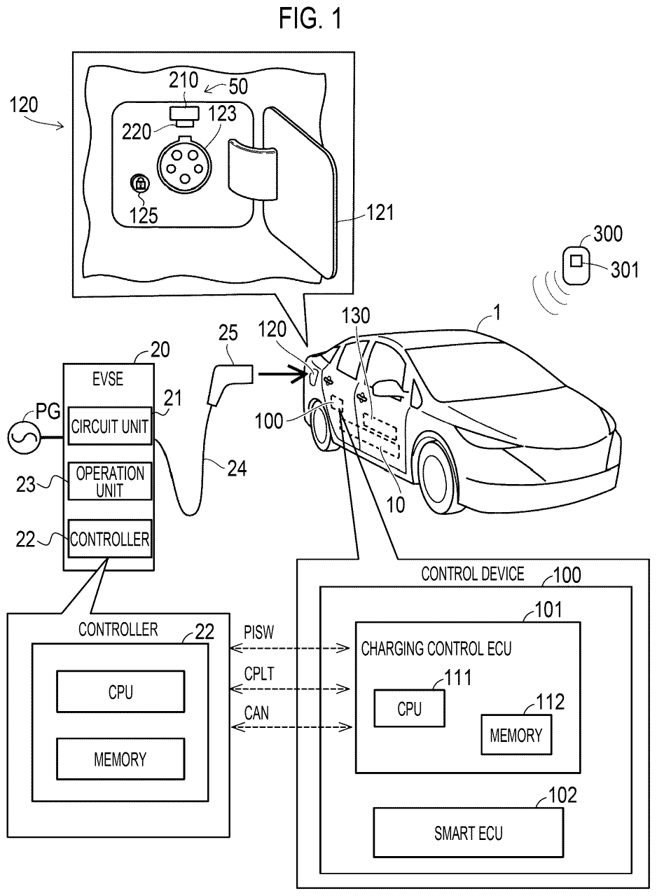

FIG. 1 is a diagram illustrating a schematic configuration of a vehicle 1 and charging equipment 20 according to the present embodiment. The vehicle 1 includes the battery 10, the control device 100, the inlet 120, and the charging circuit 130. The vehicle 1 is an electrified vehicle (xEV) configured to be able to travel using the electric power stored in the battery 10, and may be, for example, a battery electric vehicle (BEV). The battery 10 is a known secondary battery for a vehicle, and may be, for example, a lithium ion battery.

The inlet 120 includes a charging lid 121 and a charging port 123. The charging lid 121 is configured to be opened and closed by the user, and in the closed state, covers the charging port 123, and in the open state, exposes the charging port 123. When the battery 10 is charged, the charging connector 25 is connected to the charging port 123 in a state where the charging lid 121 is opened. The charging circuit 130 charges the battery 10 using the electric power supplied from the outside of the vehicle to the charging port 123.

The control device 100 includes a charging control ECU 101 and a smart ECU 102. The charging control ECU 101 includes a central processing unit (CPU) 111 and a memory 112. The smart ECU 102 also includes a CPU and a memory (not shown) in the same manner.

The electric vehicle supply equipment (EVSE) 20 charges the battery 10 with the electric power supplied from an external power supply PG (for example, a power system). The EVSE 20 includes a circuit unit 21 and a controller 22. The EVSE 20 further includes a charging cable 24 that extends from the main body of the EVSE 20 to the outside. The controller 22 includes a CPU and a memory, and controls the circuit unit 21. The circuit unit 21 includes, for example, a power conversion circuit and a circuit that charges the battery 10 with power supplied from the external power supply PG. A charging connector (plug) 25 that can be attached and detached to a charging port 123 of the inlet 120 is provided at a tip of the charging cable 24. By connecting the charging connector 25 to the inlet 120 (charging port 123) of the vehicle 1, the charging from the EVSE 20 to the vehicle 1 (battery 10) is possible.

The EVSE 20 includes an operation unit 23. The operation unit 23 may be constituted of, for example, a touch panel display including a display unit. The operation unit 23 has a charging start button and an operation button for operating a lock and an unlock of a lock mechanism described later.

The charging connector 25 has a connector terminal (not shown) formed on an end surface connected to the inlet 120 (charging port 123). The connector terminal includes a terminal L1, a terminal L2, a terminal PE, a terminal PP, and a terminal CP. The inlet terminal is provided in the charging port 123 of the inlet 120, in the same manner as the connector terminal. The terminals L1, L2 are terminals to which electric power is supplied. For example, in a case of direct current (AC) power, the terminals L1, L2 may be a hot terminal or a cold terminal. The terminals L1, L2 may be a positive electrode terminal or a negative electrode terminal in a case of direct current (DC) power. The terminal PE is a ground (GND) terminal.

The terminal PP is a terminal (hereinafter, also referred to as a “PISW”) for detecting a connection state between the charging connector 25 and the inlet 120 (proximity detection). The terminal PP outputs a potential signal (PISW signal) indicating the connection state of the connector to the vehicle 1 side. The terminal CP corresponds to a terminal (hereinafter, also referred to as “CPLT”) for a CPLT signal defined in, for example, “IEC/TS 62763:2013”. The CPLT signal is a pulse width modulation (PWM) signal used for communication between the vehicle 1 and the EVSE 20. The vehicle 1 and the EVSE 20 may perform High Level Communication (HLC) communication overlapped with the CPLT signal. The vehicle 1 and the EVSE 20 may be configured to perform a controller area network (CAN) communication.

In the present embodiment, the inlet 120 is provided with a lock mechanism 50. The lock mechanism 50 includes the actuator 210 and the lock pin 220. The actuator 210 is controlled by the control device 100 and the controller 22 to drive the lock pin 220 forward and backward. The lock mechanism 50 brings the charging connector 25 into the locked state, in which the charging connector 25 is not pulled out from the inlet 120, when the charging connector 25 is fitted to the inlet 120. In the locked state, the lock pin 220 protrudes and engages with the recess of the charging connector 25. As a result, the charging connector 25 is in a locked state in which the charging connector 25 cannot be pulled out from the inlet 120. The lock pin 220 may be configured to come into contact with a latch provided in the charging connector 25 and to be in a locked state such that a latch release button of the charging connector 25 cannot be operated. The position of the lock pin 220 that is in the locked state is also referred to as a lock position.

The actuator 210 causes the lock pin 220 to be advanced and retreated, and when the lock pin 220 is disengaged from the recess of the charging connector 25, the charging connector 25 can be pulled out from the inlet 120. The state is referred to as an unlocked state, and a position of the lock pin 220 in the unlocked state is also referred to as an unlock position. The configuration may be such that the contact between the latch provided in the charging connector 25 and the lock pin 220 is released, the latch release button of the charging connector 25 is operable, and the charging connector 25 is in the unlocked state. The unlocked state is a state in which the locked state is released.

In the auto mode, when the charging connector 25 is fitted to the inlet 120 and the control device 100 or the controller 22 detects that the charging connector 25 and the inlet 120 (charging port 123) are in the connection state based on the PISW signal, the actuator 210 is actuated and the locked state is set by a command from the control device 100 or the controller 22. In the manual mode, the charging connector 25 is brought into the locked state by operating a lock button (not shown) of the operation unit 23 of the EVSE 20, the lock operation by the smart key 300, and the like.

The locked state and the unlocked state of the lock mechanism 50 are also linked to the operation of the smart key 300. As a result, the lock and unlock operation of the lock mechanism 50 can be performed by using the smart key 300. The smart key 300 is a portable device carried by the user, and communicates with the smart ECU 102 to lock and unlock the door of the vehicle 1. For example, the vehicle 1 (smart ECU 102) transmits a polling signal in a low frequency (LF) band at a predetermined cycle. The smart key 300 that receives the polling signal transmits a response signal in a radio frequency (RF) band. The smart ECU 102 that receives the response signal executes the authentication process. When the authentication is established and the user performs a predetermined operation (for example, a touch operation of a touch sensor provided on a door knob of the vehicle 1), the smart ECU 102 performs the door lock and unlock (lock and unlock) and controls the actuator 210 such that the locked state and the unlocked state of the lock mechanism 50 are linked to the door lock and unlock.

The charging control ECU 101 detects the connection state between the charging connector 25 and the inlet 120 by the PISW signal, and when the lock mechanism 50 is brought into the locked state, the charging control ECU 101 cooperates with the EVSE 20 (controller 22) to prepare for charging the battery 10. When the battery 10 is ready to be charged, the charging control ECU 101 requests the EVSE 20 to start charging the battery 10 and controls the charging circuit 130. While the battery 10 is being charged, the lock mechanism 50 is in the locked state, and the charging connector 25 cannot be pulled out from the inlet 120.

In the present embodiment, the lock mechanism 50 maintains the locked state until the user performs the unlock operation. The user unlock operation is performed by operating the unlock button 125 provided in the inlet 120 or an unlock button (not shown) of the operation unit 23 of the EVSE 20. In addition, the lock mechanism 50 is brought into the unlocked state in conjunction with the unlocking of the door by the smart key 300. The unlock switch 301 provided in the smart key 300 may be operated to unlock the door and to perform the unlock operation of the lock mechanism 50.

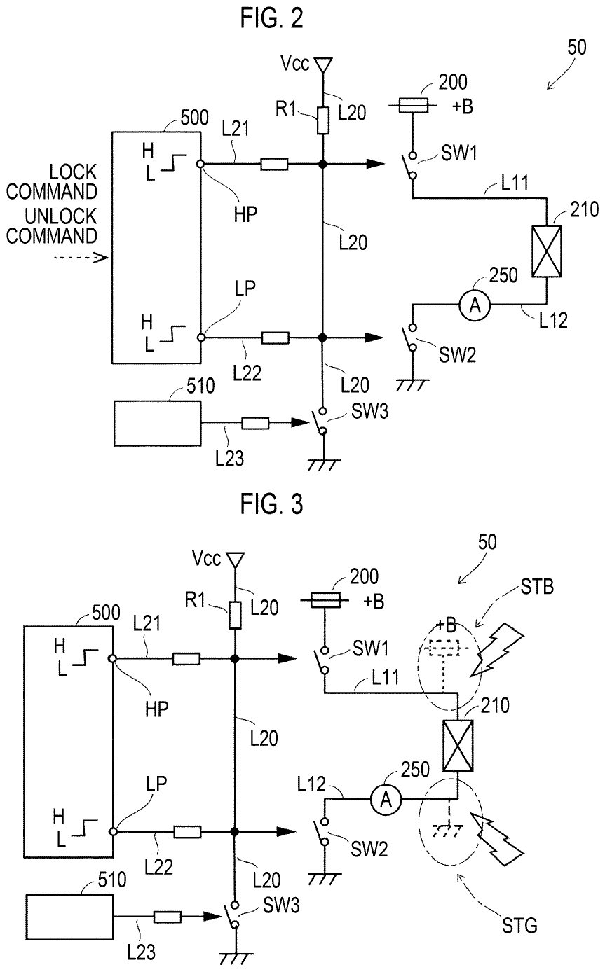

FIG. 2 is a diagram illustrating a schematic configuration of the lock mechanism 50. The actuator 210 includes, for example, an electromagnetic solenoid, and when the actuator 210 is energized, the lock pin 220 is driven to the lock position, and the lock mechanism 50 is in the locked state. When the actuator 210 is de-energized, the lock pin 220 returns to the unlock position, and the lock mechanism 50 is in the unlocked state. The actuator 210 is connected to the power supply 200 by the power line L11. The actuator 210 is connected to the ground by the power line L12. The ground may be a frame ground (chassis ground). A first switch SW1 is provided in the power line L11. A second switch SW2 is provided in the power line L12. The first switch SW1 and the second switch SW2 may be mechanical relays or may be semiconductor switches. The semiconductor switch may be an intelligent power device (IPD) or may be a field effect transistor (FET). The current monitor 250 is provided between the second switch SW2 and the actuator 210 in the power line L12. The current monitor 250 may be an ammeter.

When the first switch SW1 and the second switch SW2 are closed (turned on) and the connection state is established, the current supplied from the power supply 200 flows through the power line L11 and the power line L12, the actuator 210 is energized, and the lock mechanism 50 is in the locked state. When at least one of the first switch SW1 and the second switch SW2 is opened (turned off) and is brought into the cutoff state, the current flowing through the power line L11 and the power line L12 is cutoff and the actuator 210 is de-energized, so that the lock mechanism 50 is brought into the unlocked state.

The first switch SW1 and the second switch SW2 are controlled by the first controller 500. The first controller 500 may be a functional block of the charging control ECU 101, and may be configured of hardware provided in the charging control ECU 101. The first controller 500 includes a high-side output terminal HP and a low-side output terminal LP. The high-side output terminal HP is connected to a signal line L21. The low-side output terminal LP is connected to a signal line L22. The first switch SW1 is turned on when the signal of the signal line L21 is a high-level signal (H signal), and is turned off when the signal of the signal line L21 is a low-level signal (L signal). The second switch SW2 is turned on when the signal of the signal line L22 is the H signal, and is turned off when the signal of the signal line L22 is the L signal. The reference voltage Vcc is applied to the signal line L21 and the signal line L22 via the pull-up resistors R1. The reference voltage Vcc may be applied to the signal line L21 and the signal line L22 by the reference voltage line L20, and may be, for example, +5 [V].

The first controller 500 receives the lock command and the unlock command from the controller 22 of the EVSE 20, the charging control ECU 101, and the smart ECU 102. The lock command is a command to put the lock mechanism 50 into the locked state. The unlock command is a command for bringing the lock mechanism 50 into the unlocked state. When the first controller 500 receives the lock command, the first controller 500 outputs the H signal from the high-side output terminal HP and the low-side output terminal LP. In a case where the unlock command is received, the first controller 500 outputs the L signal from the high-side output terminal HP and the low-side output terminal LP. The voltage of the H signal may be, for example, +5 [V], and the voltage of the L signal may be 0 [V]. When the outputs of the high-side output terminal HP and the low-side output terminal LP are unstable (in a high-impedance state), the signals of the signal line L21 and the signal line L22 are fixed to the H signal by the pull-up resistor R1.

The reference voltage line L20 is connected to the ground via a third switch SW3. The second switch SW2 may be a mechanical relay or may be a semiconductor switch. The third switch SW3 is controlled by the second controller 510. The second controller 510 is configured to detect an abnormality or a failure of the first controller 500, and may be an ECU provided in the control device 100, a functional block of the controller 22, or the like. When the first controller 500 is normal, the second controller 510 outputs an L signal to the signal line L23. The second controller 510 outputs an H signal to the signal line L23 when the first controller 500 is abnormal. The third switch SW3 is turned off (cutoff state) when the signal of the signal line L23 is the L signal. The third switch SW3 is turned on (connection state) when the signal of the signal line L23 is the H signal. The abnormality of the first controller 500 includes the charging control ECU 101 and the controller 22 that output the lock command and the unlock command.

When the third switch SW3 is turned off (when the first controller 500 is normal), in a case where the first controller 500 receives the lock command, the signals of the signal line L21 and the signal line L22 are H signals, and thus the first switch SW1 and the second switch SW2 are turned on (connection state). As a result, the actuator 210 is energized, and the lock mechanism 50 is brought into the locked state. In this state, when the first controller 500 receives the unlock command, the signals of the signal line L21 and the signal line L22 become the L signal, so that the first switch SW1 and the second switch SW2 are turned off (cutoff state). As a result, the energization of the actuator 210 is cut off and the actuator 210 is de-energized, and the lock mechanism 50 is brought into the unlocked state (the locked state is released).

FIG. 3 is a diagram illustrating the short-to-power or short-to-ground in the lock mechanism 50. As shown in FIG. 3, when the power line L11 between the first switch SW1 and the actuator 210 is short-circuited to the power supply 200, a short-to-power STB occurs in the power supply line of the actuator 210. When the short-to-power STB is generated, or when the first switch SW1 is stuck in a failure, or when an abnormality occurs in the high-side output terminal HP or the signal line L21, the first controller 500 receives the unlock command and controls the first switch SW1 to be turned off (cutoff state), but the connection between the power supply 200 and the actuator 210 cannot be cut off. Even in such a case, in the lock mechanism 50 of the present embodiment, the second switch SW2 is turned off by the L signal output from the low-side output terminal LP. As a result, the energization to the actuator 210 can be cut off, and the lock mechanism 50 can be brought into the unlocked state.

As shown in FIG. 3, a ground fault STG may occur in the power line L12 between the second switch SW2 and the actuator 210. When the ground STG occurs, or when the second switch SW2 fails, or when the abnormality occurs in the low-side output terminal LP or the signal line L22, the first controller 500 receives the unlock command and turns the second switch SW2 off (cutoff state), but the connection between the ground and the actuator 210 cannot be cut off. Even in such a case, in the lock mechanism 50 of the present embodiment, the first switch SW1 is turned off by the L signal output from the high-side output terminal HP. As a result, the energization to the actuator 210 can be cut off, and the lock mechanism 50 can be brought into the unlocked state.

When an abnormality or a failure occurs in the first controller 500, the first controller 500 may not be able to control the first switch SW1 and the second switch SW2. In this case, even when the first controller 500 receives the unlock command, the first switch SW1 and the second switch SW2 cannot be turned off, and the locked state of the lock mechanism 50 cannot be released to be in the unlocked state. When the abnormality occurs in the first controller 500, the second controller 510 outputs the H signal to the signal line L23. Then, the third switch SW3 is turned on (connection state). When the third switch SW3 is in the connection state, the signal line L21 and the signal line L22 are connected to the ground via the third switch SW3, and the signals of the signal line L21 and the signal line L22 are fixed to the L signal. As a result, the first switch SW1 and the second switch SW2 are turned off (cutoff state), and the actuator 210 is de-energized, so that the lock mechanism 50 can be brought into the unlocked state.

Even when the abnormality occurs in the first controller 500 and the short-to-power STB occurs (or when the first switch SW1 is stuck and fails), the third switch SW is turned on by the second controller 510, so that the second switch SW2 is turned off, the actuator 210 is de-energized, and the lock mechanism 50 is brought into the unlocked state. Even when the abnormality occurs in the first controller 500 and the ground fault STG occurs (or when the second switch SW2 is stuck), the third switch SW is turned on by the second controller 510, so that the first switch SW1 is turned off, the actuator 210 can be de-energized, and the lock mechanism 50 is brought into the unlocked state.

According to the present embodiment, the lock mechanism 50 switches between the locked state and the unlocked state by the actuator 210 that locks the charging connector 25 in the locked state when the actuator 210 is energized and unlocks the charging connector 25 in the unlocked state when the actuator 210 is de-energized. The first controller 500 of the control device brings the charging connector 25 into the locked state by bringing the first switch SW1 and the second switch SW2 into the connection state. The first switch SW1 is provided on the power supply 200 side of the actuator 210, and the second switch SW2 is provided on the ground side of the actuator 210. When the short-to-power occurs on the power supply side of the actuator 210, the actuator 210 is de-energized and the charging connector 25 is brought into the unlocked state when the second switch SW2 is brought into the cutoff state. When the ground side of the actuator 210 is grounded, the actuator 210 is de-energized and the charging connector 25 is brought into the unlocked state when the first switch SW1 is brought into the cutoff state. Therefore, even when short-to-power or a short-to-ground occurs on the power supply line to actuator 210, the locked state can be released.

According to the present embodiment, the lock mechanism 50 includes the second controller 510 that brings at least one of the first switch SW1 and the second switch SW2 into the cutoff state and that brings the charging connector 25 into the unlocked state when the abnormality occurs in the first controller 500. Even when the abnormality occurs in the first controller 500, the second controller 510 can bring the charging connector 25 into the unlocked state by turning the first switch SW1 or the second switch SW2 into the cutoff state.

The lock mechanism 50 includes a signal line L21 (first signal line) and a signal line L22 (second signal line) connected to the first controller 500, and a third switch SW3 controlled by the second controller 510. When the connection command is output from the first controller 500 to the signal line L21, the first switch SW1 is brought into the connection state. When the connection command is output from the first controller 500 to the signal line L22, the second switch SW2 is brought into the connection state. When the third switch SW3 is turned on by the second controller 510, at least one of the command of the signal line L21 and the signal line L22 is a cutoff command. Therefore, even when the abnormality occurs in the first controller 500, the second controller 510 can bring the first switch SW1 or the second switch SW2 into the cutoff state and bring the charging connector 25 into the unlocked state.

In the above-described embodiment, the first switch SW1 and the second switch SW2 are configured to be turned on (connection state) when the H signal is output from the high-side output terminal HP and the low-side output terminal LP. However, the first switch SW1 and the second switch SW2 may be configured to be turned on (connection state) when the L signal is output from the high-side output terminal HP and the low-side output terminal LP. In this case, when the lock command is received, the first controller 500 outputs the L signal to the high-side output terminal HP and the low-side output terminal LP, and when the unlock command is received, the first controller 500 outputs the H signal. Then, when the third switch SW3 is turned on, the circuit may be configured to fix the signal line L21 and the signal line L22 to the H signal.

In the above-described embodiment, the actuator 210, the lock pin 220, the first controller 500, and the like are provided in the vehicle 1. However, the actuator 210, the lock pin 220, the first controller 500, and the like may be provided in the EVSE 20. For example, the actuator 210 and the lock pin 220 may be provided in the charging connector 25, and the first controller 500 may be provided in the controller 22. In this case, for example, the lock pin 220 may be engaged with a recess provided in the inlet 120 to bring the charging connector 25 into the locked state. The lock mechanism 50 may be appropriately provided to the vehicle 1 and the EVSE 20 in a distributed manner. For example, the actuator 210 and the lock pin 220 may be provided in the vehicle 1 (inlet 120), and the first controller 500 may be provided in the EVSE 20 (controller 22). In this case, the first switch SW1 or the like may be controlled by the CPLT communication (HLC communication) or the CAN communication. The second controller 510 may be provided in any of the control device 100 and the controller 22. The control device 100 and the controller 22 correspond to an example of a “control device” in the present disclosure.

### Modification

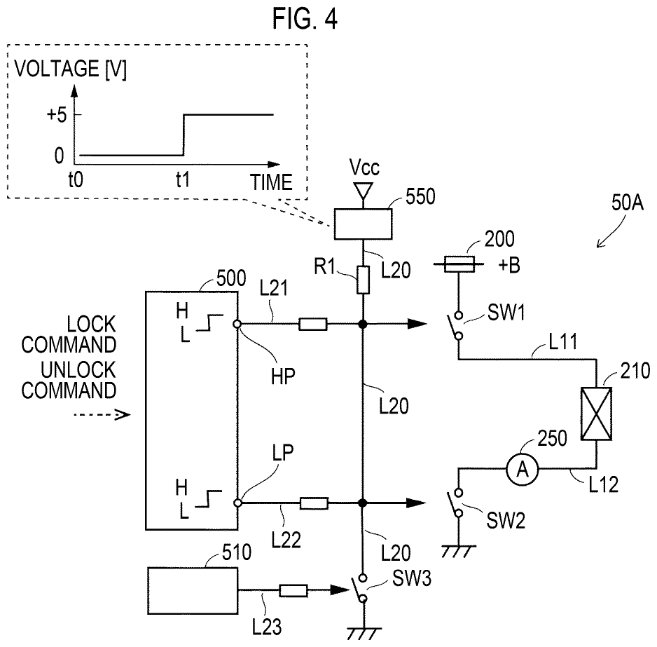

FIG. 4 is a diagram illustrating a schematic configuration of the lock mechanism 50A in the modification. The lock mechanism 50A of the modification is provided with a delay circuit 550 between the power supply of the reference voltage Vcc and the pull-up resistor R1. Other configurations are the same as those of the above-described embodiment. The delay circuit 550 delays the reference voltage Vcc and supplies the delayed reference voltage Vcc to the pull-up resistor R1 when the lock mechanism 50A is connected to the power supply for the first time (initial power supply turn-on). As indicated by a dashed line in FIG. 4, at time t0, when the power supply is turned on in the lock mechanism 50, the reference voltage Vcc supplied to the pull-up resistor R1 is 0 [V] because the reference voltage Vcc is delayed by the delay circuit 550. Then, after the power supply of the lock mechanism 50 is turned on, when the time is t1, the reference voltage Vcc (+5 [V]) is supplied to the pull-up resistor R1. After the power supply of the lock mechanism 50 is turned on, the reference voltage Vcc supplied to the pull-up resistor R1 is 0 [V] from time t0 to time t1, and thus the pull-up resistor R1 acts as a pseudo pull-down resistor. As a result, between time t0 and time t1, the signals of the signal line L21 and the signal line L22 are fixed to the L signal (0 [V]). Therefore, between time t0 and time t1, the first switch SW1 and the second switch SW2 are turned off (cutoff state), and the lock mechanism 50 is brought into the unlocked state.

After time t1, the signals of the signal line L21 and the signal line L22 are fixed to the H signal by the pull-up resistor R1. Therefore, when the first controller 500 is activated, such as when the first controller 500 is reset by the watchdog timer when the first controller 500 returns from the sleep state, the signals of the signal line L21 and the signal line L22 are fixed to the H signal by the pull-up resistors R1, the first switch SW1 and the second switch SW2 are turned on (connection state), and the lock mechanism 50 is brought into the locked state. The activation of the first controller 500 may include the activation of the control device 100 (charging control ECU 101) or the controller 22.

The lock mechanism 50 is in the unlocked state when the power supply of the lock mechanism 50 is turned on according to the modification. Therefore, the lock mechanism 50 can be suppressed from being unintentionally brought into the locked state. Further, at the time of the activation of the first controller 500, such as when the first controller 500 is returned from the sleep state after time t1, the lock mechanism 50 holds the locked state. As a result, the charging connector 25 can be suppressed from being unintentionally brought into the unlocked state. Therefore, when the first controller 500 is activated, the charging connector 25 can be suppressed from being unintentionally pulled out from the inlet 120. After the first controller 500 is activated, the lock mechanism 50 can be controlled to the locked state/unlocked state by the output signals (H signal, L signal) of the high-side output terminal HP and the low-side output terminal LP. In addition, the third switch SW3 controlled by the second controller 510 can bring the lock mechanism 50 into the unlocked state.

The H signal and the L signal (output signals of the high-side output terminal HP and the low-side output terminal LP) on the signal line L21 and the signal line L22 correspond to the “command (connection command or cutoff command)” of the present disclosure.

The embodiment disclosed is to be considered merely illustrative and not restrictive in all respects. The scope of the disclosure is defined not by the detailed description of embodiments but by the claims, and is intended to cover all equivalents and all modifications within the scope of the claims.

What is claimed is:

1. A lock mechanism that locks a charging connector connected to an inlet, the lock mechanism comprising:
an actuator that brings the charging connector into a locked state when energized and brings the charging connector into an unlocked state when de-energized;
a first switch provided on a power supply side of the actuator;
a second switch provided on a ground side of the actuator; and
a control device,
wherein the control device includes a first controller that brings the charging connector into the locked state by bringing the first switch into a connection state and the second switch into a connection state.

2. The lock mechanism according to claim 1, wherein the control device includes a second controller that, when an abnormality occurs in the first controller, brings at least one of the first switch and the second switch into a cutoff state and brings the charging connector into the unlocked state.

3. The lock mechanism according to claim 2, further comprising:
a first signal line connected to the first controller;
a second signal line connected to the first controller; and
a third switch controlled by the second controller, wherein:
the first switch is brought into the connection state when a connection command is output from the first controller to the first signal line;
the second switch is brought into the connection state when a connection command is output from the first controller to the second signal line; and
a command of at least one of the first signal line and the second signal line is a cutoff command when the third switch is connected by the second controller.

4. The lock mechanism according to claim 1, further comprising:
a first signal line that is connected to the first controller;
a second signal line that is connected to the first controller; and
a circuit that, when the first controller is activated, generates connection commands to the first signal line and the second signal line to bring the first switch into the connection state and the second switch into the connection state, and to bring the charging connector into the locked state,
wherein the first controller outputs commands to the first signal line and the second signal line after being activated.
